(19) United States
(12) Patent Application Publication
(10) Pub. No.: US 2007/0255746 A1
(43) Pub. Date: Nov. 1, 2007

(54) Method for Processing Associated Software Data

(76) Inventors: Mireille Summa, Pommeuse (FR); Frederick Vautrain, Paris (FR); Mathieu Barrault, Paris (FR); Fabrice Rossi, Paris (FR)

Correspondence Address: YOUNG & THOMPSON, 745 SOUTH 23RD STREET, 2ND FLOOR, ARLINGTON, VA, 22202, US

(21) Appl. No.: 11/631,152

(22) PCT Filed: Jul. 4, 2005
(86) PCT No.: PCT/FR05/50533

§ 371 Date: Mar. 8, 2007

(30) Foreign Application Priority Data
Jul. 2, 2004 (FR) 0407348

(51) Int. Cl. G06F 17/30

(52) U.S. Cl. 707/102

(57) ABSTRACT

A method of producing, from a first conventional data table (T1) including first fields and first statistical units, a second complex data table (T2) including a plurality of classifying fields and at least one non-classifying field and second fields and second statistical units, each of the second statistical units being identified by a set identifying values constituted by possible values of the classifying fields. The method includes the following steps which consist in: selecting the first fields as classifying fields or non-classifying fields; computing the number and identifying the second statistical units with the possible values of the classifying fields; synthesizing, using a synthesis rule, the complex value associated with a second statistical unit for a non-classifying field based on conventional values of a batch of first statistical units coinciding with the second statistical unit.

The present invention relates to complex data. More specifically, the invention relates to a method, implemented by software, for generating, displaying, and outputting complex data items, or more generally any operation for preparing complex data items with a view to a complex analysis.

With the aim of establishing the meanings of the terms used in this document, the following glossary provides some definitions:
Data table: In the description that follows, a data table is a matrix representation formed of cells able to contain information. The cells are organized into rows and columns. Each column is an attribute or field (Identifier, Age, Sex, Town, etc.), and each row represents an individual or statistical unit. An individual is identified unambiguously by the value of an identifier which may be an n-tuple. This identifier can be taken up in the data table by an identification field or by several fields in the case of an n-tuple.
Monovalued or conventional data item: This is an item of information having a single value. An integer (3), a real number (1.312), a character (A) or the equivalent, are examples of conventional or monovalued data items. In a known manner, a monovalued data item is recorded in a cell of a data table. When a field is a variable taking monovalued values, this will be referred to as a conventional field. Likewise, a table containing only conventional fields will be referred to as a table of conventional data items.
Multivalued or complex data item: This is a data item such as, for example, a set of values, an interval, a distribution, a graph or the equivalent. A complex data item is also recorded in a single cell of a table. For example, an interval is a complex data item stored in a cell. This cell contains the equivalent of four values, i.e. the value of the lower limit of the interval, the value of the upper limit, an item of information providing for knowing whether the lower limit is included in or excluded from the interval and an item of information providing for knowing whether the upper limit is included in or excluded from the interval. The complex data items are for example coded in a cell by a string of characters. When a field is a variable taking multivalued values, this will be referred to as a complex field. A table containing at least one complex field will be referred to as a table of complex data items.
Aggregation: This a grouping operation for grouping together monovalued values from various cells so as to construct a quantity which is itself monovalued. For example, calculating a mean or a variance on the values of a field for a batch of individuals is an aggregation operation.
Synthesis: This a grouping operation for grouping together monovalued values from a batch of cells in order to construct a multivalued value. For example, combining the monovalued values of said batch into a complex data item of the interval type containing all these values.

Some recent theoretical work has shown the many advantages that could be drawn from the use of complex values in data analysis, and, more specifically, for the processing of very large databases containing a large number of monovalued data items grouped together into a large number of tables. These advantages are particularly important when the databases analyzed are heterogeneous in the sense that the data items they contain come from a variety of sources and/or have a variety of formats.

In a simplified manner, complex data items provide for summarizing large quantities of monovalued data items while preserving a level of information that is higher than the monovalued data items obtained by simple aggregation. Complex data items are characterized by a richer description of the initial data items than the aggregated monovalued data items. Consequently, complex data items enable finer analyses. But these analyses are of a fundamentally new type due to, among other reasons, the variety of complex operators that can be used. For this purpose, new algorithms specifically for the analysis of complex data items have been developed.

Therefore, there exists a need for a tool for producing complex data items from the content of current relational databases containing conventional heterogeneous monovalued data items in order to then provide for fine analyses using these new algorithms for processing complex data items.

In U.S. patent 2004/0034615 belonging to Business Objects S.A., a method is described for navigating among hierarchical levels each having a different level of granularity or precision. On a relational database, the administrator constructs additional data tables by executing, in advance, the queries that are most often made by the users. For example, if there is in the database a first table PRODUCTS linking the type of part to its price, and a second table INVOICING linking a customer to a type of part and to a number of parts, the administrator performs a query leading to the creation of a new table T/O giving the turnover per customer over the year. In this case, this is an information aggregation operation leading to a monovalued value. Later, when a user of the database tries to determine the turnover per customer, he sends a query to the table T/O. The information does not have to be calculated again since it is present in the database. Consequently, the response is displayed quickly on the user's screen preferably in the form of a table. Through a predefined action, for example by clicking on a cell in the table, the user can access the initial information that has been aggregated. This initial information, not yet aggregated, corresponds to a lower, more detailed, hierarchical level. For example, by clicking on the turnover of a customer, the user can determine the detail of the parts bought by the customer in question. For that purpose, the device disclosed in this patent includes a correspondence table which provides for linking the aggregated table T/O to the initial tables containing the detailed information on which the administrator carried out his query. When the user wishes to access this detailed information, the system provides for finding the content from the initial table and for presenting it to the user.

Thus, in the patent of Business Objects S.A., the aggregated data items are not complex data items. Also, this is not a matter of carrying out operations on the data items. The correspondence table simply provides for returning to the initial monovalued information from which an aggregated monovalued information item has been constructed.

A collaboration of European laboratories and companies has completed an item of software called SODAS so as to prove the complex data analysis algorithms. In the context of this collaboration, a rudimentary module for converting monovalued data items of a relational database into complex data items has been developed. The general idea of the DB2SO (“Database to Symbolic Objects”) module, is to construct, by means of a unique classifying field, a table of complex data items summarizing the information contained in a relational database. Then, by means of the analysis modules of the SODAS software, knowledge is extracted by analyzing the complex data items contained in the table of complex data items.

Let there be an initial database containing a table INHABITANT, the individuals of which are characterized by the values of the fields Sex, Age and Town. Each individual is first associated with a classifying field: an individual is associated with a particular town. A new table TOWN is then constructed. The statistical units of the table TOWN are identified by the various possible values of the classifying field Town. The columns of the table TOWN are obtained from the fields of the table INHABITANT which have not been reserved as classifying fields: Sex and Age in our example. Thus, in the new table TOWN, a particular town is described according to the field Age by a complex data item which is a generalization of the values of the same field characterizing the batch of individuals that have been associated with a particular town. In the current version of the DB2SO module, the complex data items possible are of the histogram and interval types. The analysis of complex data items can finally be performed on the new table TOWN.

It is to be noted that values of conventional fields of the initial table are synthesized by generalization operators or rules. For example an interval rule provides for converting a batch of monovalued values into an interval by taking for example the minimum and the maximum of this batch of values.

There is therefore a need for more powerful software tools in order to create tables of complex data items from relational databases. Since the operation for generating a table of complex data items with a view to a complex analysis requires the intervention of the user, it is necessary to provide the user with interfaces for easily “manipulating” the complex data items.

The invention therefore aims to solve the abovementioned problems.

A subject of the invention is a data processing method characterized in that, with the aim of producing from a first table of conventional data items containing a plurality of first fields and a plurality of first statistical units, a second table of complex data items containing a plurality of second fields and a plurality of second statistical units, said plurality of second fields being formed of a plurality of classifying fields and of at least one non-classifying field, each of said second statistical units being identified by an identifying n-tuple, each coordinate of which corresponds to a possible value from one of the classifying fields, it includes the steps of:
Selecting fields from said first fields as classifying fields, then at least one field from said first fields that have not been selected as classifying field as non-classifying field;
Constructing said second table with a number of columns corresponding to the number of second fields and a number of rows corresponding to the number of second statistical units, which is at most equal to the product of the number of possible values of each of said classifying fields;
Determining said identifying n-tuple associated with each of said second statistical units and completing the corresponding cells of said second table;
Synthesizing, by means of a synthesis rule, the complex value of a second statistical unit according to a non-classifying field from a batch of conventional values of first statistical units according to the first field from which said non-classifying field is derived, the first statistical units of said batch having values according to the first fields from which said classifying fields are derived coinciding with the coordinates of said identifying n-tuple of said second statistical unit; and,
Completing a corresponding cell of said second table with said complex value resulting from the synthesis step.

Advantageously, the method according to the invention provides for constructing tables of complex data items, said complex data items having been constructed from a plurality of classifying fields, while preserving each of the classifying fields as a field of the table of complex data items.

Preferably, the method includes an additional step involving the displaying of said second table by graphically presenting said complex values to a user. Also preferably, the method includes the steps of:
Choosing two classifying fields from said plurality of classifying fields as row field and column field, and one field from said second fields that have not been chosen from said second table as the field chosen to be represented; and,
Generating a cross-tabulated table, the rows of which correspond to possible values of said row field, the columns of which correspond to possible values of said column field, and the cells of which contain the complex values of said field chosen to be represented.

Advantageously, when a table containing two classifying fields can be extracted from the table of complex data items, it is possible to present this table to the user in the form of a cross-tabulated table.

Preferably, when the second table includes another classifying field in addition to the fields chosen as row and column fields, either said other classifying field is the field chosen to be represented and said step for generating a cross-tabulated table includes a step for synthesizing a batch of values of second statistical units, or said other classifying field is not the field chosen to be represented and the step for generating a cross-tabulated table includes an aggregation of said batch of values of second statistical units, said second statistical units of said batch having identifying n-tuple coordinates according to the two coordinates corresponding to the row and column fields which are identical.

Preferably, the method includes an initial data import step to construct said first table of conventional data items according to a predetermined format.

Preferably, said first table resulting from the import step is a first raw table, and the method includes a filtering step which involves filtering the content of said first raw table in order to obtain said first table.

Preferably, the method includes a step which involves defining the range of possible values of a first field so as to order said values in order to be able to graphically present the complex values of the non-classifying field derived from said first field.

Preferably, the method includes a step involving selecting the synthesis rule associated with said non-classifying field during said synthesis step.

Another subject of the invention is a data processing software to implement a method according to one of the methods above, characterized in that, from a first table of conventional data items containing a plurality of first fields and a plurality of first statistical units, it is able to produce a second table of complex data items containing a plurality of second fields formed of a plurality of classifying fields and of at least one non-classifying field, and a plurality of second statistical units respectively identified by an identifying n-tuple, each coordinate of which corresponds to a possible value of one of said classifying fields, and in that it includes:
a means for selecting fields as classifying fields from said plurality of first fields, and at least one field as non-classifying field from said first fields that have not been selected as classifying fields;
a means for determining second statistical units which is able to determine said identifying n-tuples from possible values of said first fields selected as classifying fields; and,
a synthesis means able to compute a complex value of a second statistical unit according to said non-classifying field, from a batch of conventional values of first statistical units according to the first field from which said non-classifying field is derived, the first statistical units of said batch having values according to the first fields from which said classifying fields are derived coinciding with the coordinates of said identifying n-tuple of said second statistical unit.

Preferably, the software includes a displaying module able to graphically present said complex values to a user.

Preferably, the software includes a means for choosing two classifying fields from said plurality of classifying fields as row field and column field, and one field from said second fields that have not been chosen from said second table as the field chosen to be represented, and a cross-tabulated table generation means able to generate a cross-tabulated table, the rows of which correspond to possible values of said row field, the columns of which correspond to possible values of said column field, and the cells of which contain the complex values of said field chosen to be represented.

Preferably, the software includes a data import means able to construct said first table of conventional data items according to a predetermined format.

Preferably, said first table constructed by said import means is a first raw table, and the software includes a filtering means for filtering the content of said first raw table in order to obtain said first table.

Preferably, the software includes a range-editing means for defining the range of possible values of a first field with the aim of ordering said values in order to be able to graphically present the complex values of the non-classifying field derived from said first field.

Preferably, the software includes a synthesis rule selection means for selecting the synthesis rule associated with said non-classifying field during said synthesis step.

Another subject of the invention is a programmed computer-based architecture able to execute the instructions of software, characterized in that said software corresponds to one of the items of software described above.

The invention will be better understood from the following description given by way of nonlimiting example with reference to the accompanying drawings in which:

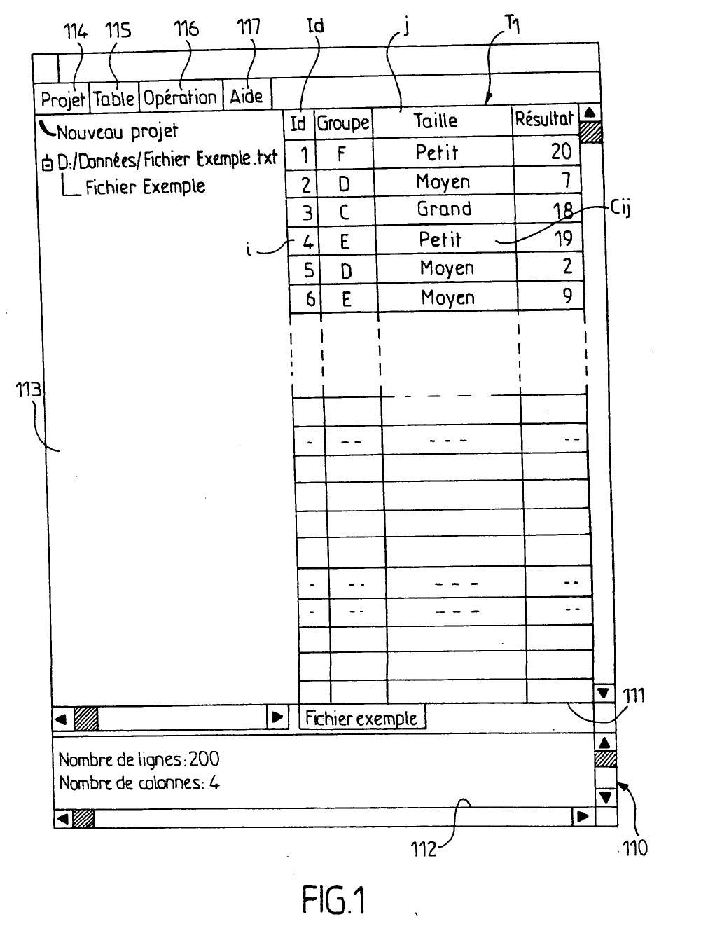

FIG. 1 represents a window displaying a first table of conventional data items;

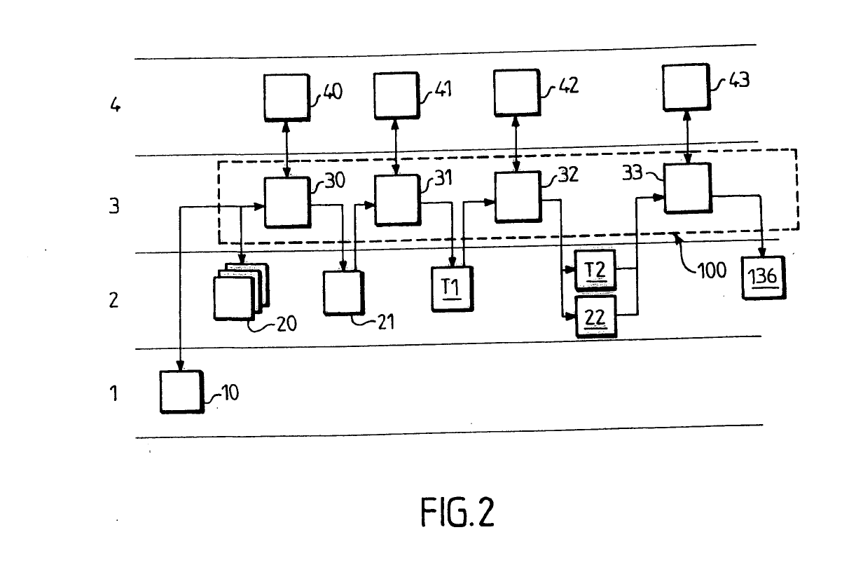

FIG. 2 is a block diagram of the steps of the method according to the invention implemented in a particular computer-based architecture;

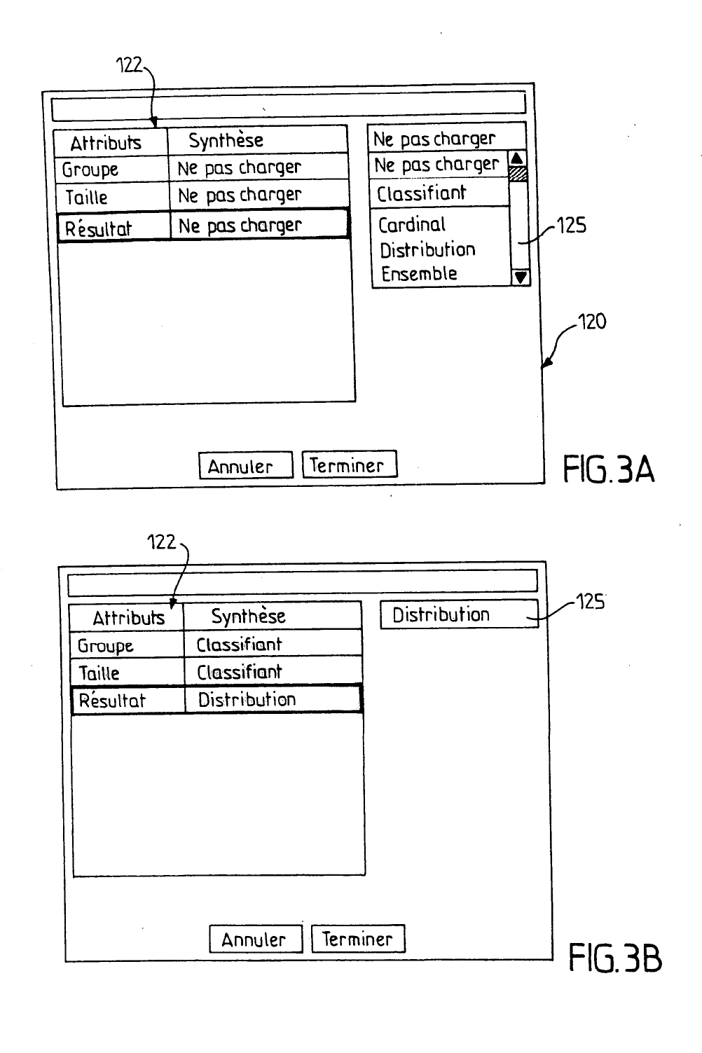

FIGS. 3A and 3B respectively represent a window enabling the user to determine the parameters of a synthesis;

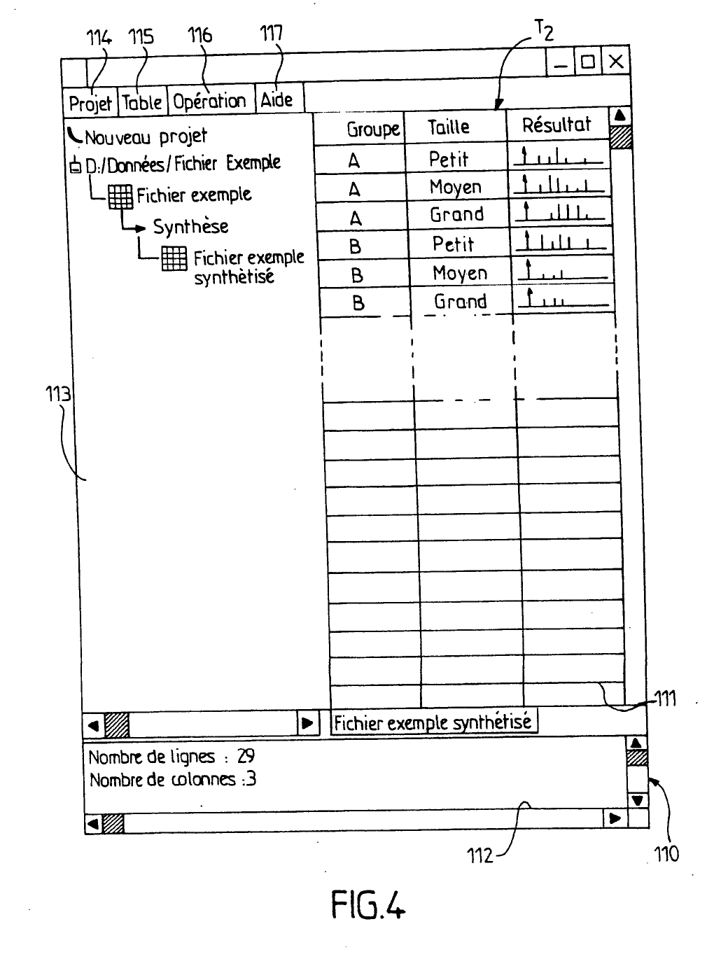

FIG. 4 represents a window displaying a second table of complex data items;

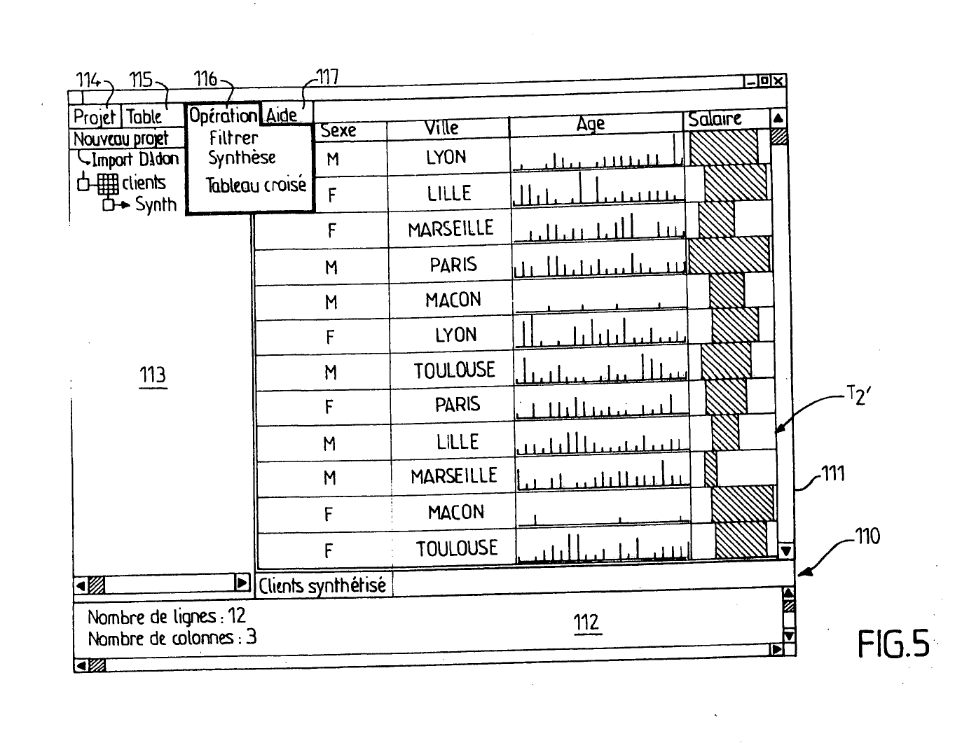

FIG. 5 represents another example of a second table of complex data items;

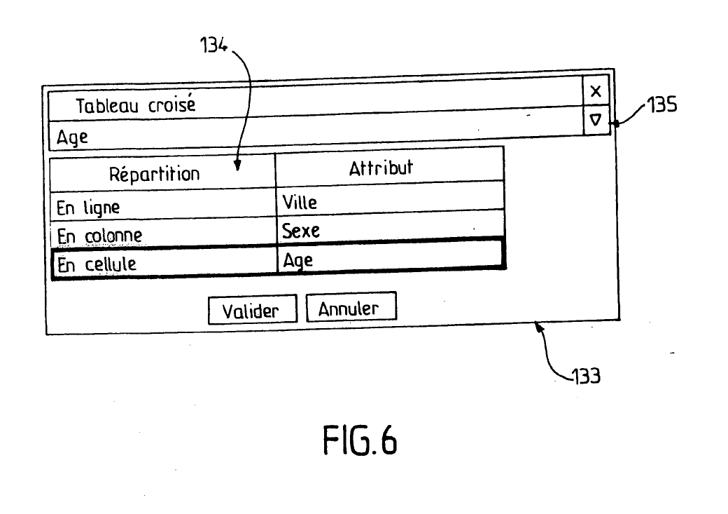

FIG. 6 represents a window enabling the user to enter the settings for a cross-tabulated table from the second table of FIG. 5; and,

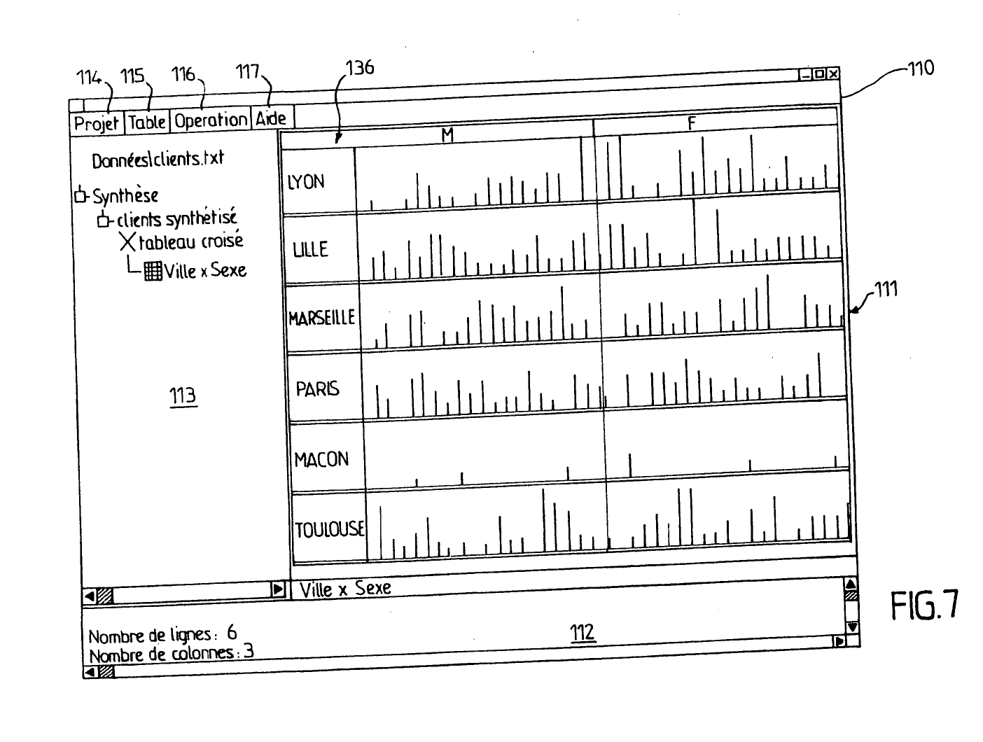

FIG. 7 represents a cross-tabulated table obtained according to the settings of FIG. 6 from the table of FIG. 5.

The method according to the invention is preferably implemented in the form of data processing software. The software includes a series of instructions executable by a host computer. The host computer includes a memory able to store the software instructions and a processor able to execute the software instructions. The host computer includes an operating system for which the software according to the invention appears as an application. The host computer manages various peripheral devices such as a screen, a mouse, etc., enabling the user to interact with the software through a man-machine interface. As a variant, the computer-based architecture can be distributed in the sense that a user having a remote computer connected to the host computer by means of a network supporting the TCP/IP protocol can interact with the software.

During each new execution of the software, a new work session is initialized. All the data processing operations which will have taken place will be saved with an identifier characterizing the current session. The user can also leave the current session and load a previous session in order to continue the data processing operations undertaken during this previous session.

When the user starts the execution of the data processing software according to the invention, a man-machine interface, of a known type moreover, formed of windows, frames and scrolling menus, appears on the screen. The scrolling menus present various choices of functions. When the user selects a function, the corresponding software module is executed carrying out an associated operation.

In FIG. 1, a window 110 containing three frames 111 to 113 and four menus 114 to 117 forms the software interface. The interface 110, forming a displaying means, includes a frame 111 in which there is presented a current table to which the data processing operations relate. A table of conventional data items T1 is presented by way of example in the frame 111 of FIG. 1. It includes a plurality of rows and a plurality of columns. The frame 112 indicates that the table includes 200 rows and four columns. Each row of the table corresponds to a statistical unit. Each column corresponds to a field, having a name, a set of possible values and possibly a relationship or domain providing for classifying or ordering, one with respect to the other, the possible values of this field. It is to be noted that the set of possible values can be continuous. The statistical unit is characterized by the particular values that the various fields take.

In FIG. 1, since the table T1 is a table of conventional data items, the values of the various fields are monovalued data items. Thus, the cell Cᵢⱼ of the table T1 corresponds to the value of the field associated with the column j and to the statistical unit associated with the row i, in this case, the value “Small” of the field “Size” of the fourth individual. The first field of a table is, in general, an identifier field “Id” for identifying each statistical unit. In the table T1, the identification is achieved by a unique integer.

In FIG. 2, the data processing software 100 includes an import means 30 for importing files in which the data items are stored in formats that are different from the predetermined type format of the first table T1. For example, the import means 30 provides for importing the content of a text file 10 stored on a remote computer 1. In the text file 10, the values associated with each statistical unit are written on a row and separated from each other by a delimiter such as a vertical bar. Preferably, the import means 30 includes an interface in which the user enters settings for the import, defining the file to import, the delimiter between the data items, the data items to take into account, the field names, the set of acceptable values for a field, etc. This work can also be achieved automatically by the import means 30.

The software can be connected to a relational type database 2. This connection is achieved by choosing a link pointing to the database 2. With the link is associated the language required to work with the database 2. This can be a simple read connection to-load the content of a table 20 of the database 2 to the random access memory (RAM) of the host computer.

As a variant, as represented in FIG. 2, the connection is a read/write connection and the processing software 100 stores no longer in the RAM of the computer 3 but in the relational database 2 the results of the operations performed during a session, such as the updating of values of a table, the creation of an intermediate table, etc. The issue of storing data is more a question of the speed of access to the data than of the structure of the software according to the invention.

It will be noted that the import operation could be achieved with the tools of the relational database 2 to generate a first data table of an appropriate type residing in the database 2. But, the advantage of integrating an import means in the processing software 100 lies in proposing to the user a single centralized tool to prepare the data items on which he wishes to carry out his analysis. Furthermore, the import operation performed at the level of the database 2 necessitates knowledge of the language of the engine associated with the database. Integrating an import module 30 in the software frees the user from this knowledge.

The first table created by importing can be displayed on the user's screen 4 (step 40). This can be a first raw table 21 requiring a filtering step 31 to produce a first table T1 of conventional data items. Either the user himself filters the imported values via the interface 110, or the software 100 has automatic filtering means. For example, by selecting a column of the first raw table 21, the software presents the characteristic values of this column to the user: minimum value, maximum value, mean, standard deviation, etc. The user can then choose to delete individuals that deviate too much from the average value. The software then automatically filters the raw table 21 to obtain a new table. The filtering operation continues until a first table of conventional data items T1 is obtained able to undergo a synthesis operation.

The software 100 also includes a range creation means. An interface enables the user to view the set of possible values of a field. The user can restrict the possible values. The individuals characterized by a value that is not retained in the restricted range thus defined takes an undefined value. This selection of possible values for constraining or restricting the import is equivalent in the end to applying a filter.

The user can order the possible values one with respect to the other so as to create an order relationship on this range. The user can also define a distance between the possible values of the field. This ordering of the set of possible values of a first field of the first table T1 is of special interest for graphically representing the complex value of a field derived from this ordered field, as will be described below.

The software 100 includes a feature for associating various elementary tables to form a first table of conventional data items T1.

Next, a synthesis 32 is performed on the first table of conventional data items T1 so as to create a second table of complex data items T2: some of the fields of the latter are complex. The synthesis operation 32 is started by selecting, from the “Operation” menu, the “Synthesis” function. A window 120 of the type as represented in FIG. 3A appears on the screen 4. This step is represented in FIG. 2 by the element 42. The fields of the first table T1 are presented in the first column of the table 122. From the set of first fields, the user is invited to select those which he wishes to see as classifying fields of the second table T2. Then, from the fields of the first table T1 which have not been selected as classifying fields, the user selects first fields as non-classifying fields of the second table T2.

By default, the data items of a first field which is not selected as a classifying field or as a non-classifying field are not loaded in the second table T2. This corresponds to the case in which the user judges that the variable which this unselected first field represents is not useful in the continuation of the analysis.

For a first field selected as a non-classifying field of the second table T2, the user chooses the complex data type which must be associated with this non-classifying field: a distribution, a set, a number of entries, a graph, an interval or the equivalent. By associating a complex data type with a non-classifying field, the synthesis rule which will be used to calculate the complex value can be defined.

The software makes provision for adding additional modules for complex data types according to the needs of the user and according to developments leading to the emergence of a new complex data type. A complex data type module includes the synthesis rule to be used during the synthesis of a batch of values. The name of the corresponding complex data type appears in the scrolling menu 125 of the synthesis interface.

Once the user has validated the parameters for his synthesis by pressing the “Finish” button of the interface represented in FIG. 3B, the synthesis starts by searching for second statistical units of the second table T2.

The user has selected N classifying fields. The n^{th} classifying field has Lₙ possible values which are the Lₙ possible values of the first field from which the n^{th} classifying field is derived. For example the following algorithm could be used to determine the set of possible values Vₗₙ of the n^{th} classifying field (where K is the total number of first statistical units of the first table T1):

Start
N classifying fields
Order T1 to make the N classifying fields appear as table headers
Loop on n from 1 to N

K first statistical units
Initialization of a variable V1ₙ
Sort the rows of T1 by the values of the cells of column n
Loop on k from 1 to K

Read T1(kn) value of cell row k column n of T1
Compare T1(kn) with the current value V1ₙ of the n^{th}
classifying field
If T1(kn) = V1ₙ

Loop on k

Else

Increment the counter 1ₙ giving the number of possible
values
Assign to V1_{n the value T1(kn) of the field n}
Loop on k

Assign the last value of 1ₙ to Lₙ

End

Therefore, the maximum number I of second statistical units is given by the product of N numbers Lₙ. The second table T2 initially contains I rows. The second table T2 can then be generated in the memory space or in the database. The first N columns of this second table T2 correspond to the N classifying fields. The second fields following correspond to the non-classifying fields.

Each second statistical unit is then identified by an identifying n-tuple with N coordinates, each coordinate corresponding to one of the possible values of one of the N classifying fields. For each statistical unit of the second table T2, the aim is therefore to complete the N first cells with possible values of the classifying fields, but with the constraint that the identifying n-tuples must be different from one second statistical unit to another. An algorithm such as the following algorithm can be used:

Start
N nested loops containing integer counters 1ₙ, from 1 to Lₙ

Loop on n from 1 to N

T2 second table ordered to start with the N classifying
fields
Write the value V1ₙ in the cell T2(in) of T2
Loop on n

Increment the integer counter i

End

The synthesis continues by completing the cells of the second part of the second table T2 formed by the columns of the non-classifying fields. For a given identifying n-tuple, the aim is to synthesize the conventional values of the first field, from which the non-classifying field is derived, of a batch of first statistical units. The first statistical units of this batch are characterized in that the N values of the first fields chosen as classifying fields coincide with the N coordinates of the identifying n-tuple in question. This synthesis is performed by means of the rule which has been associated with the non-classifying field. Through successive nested loops, the various cells of the second part of the second table are completed and the corresponding complex data items are stored in the memory space of the computer or in the associated relational database. For this step, an algorithm equivalent to the following algorithm is executed:

Start
M a non-classifying field
I the product of the numbers Lₙ, of values of the N classifying
fields
Loop on i from 1 to I

K number of first statistical units
Loop on k from 1 to K

If T2(in) = T1(kn) for any n from 1 to N
Then Synthesize the value T1(kM) with the current value
of T2(iM) using the rule R and write the new value of
T2(iM)
Loop on k

Loop on i

End

At the end of the synthesis operation 32 (FIG. 2) and of the generation of the second table T2, the user accesses the content of the second table T2 via the displaying interface 110, as represented in FIG. 4. The displaying means of the software of the present invention allows the complex values contained in the cells of the second table T2 to be presented in graphical form. In the frame 111, the first two columns correspond to the classifying fields “Group” and “Size”. The maximum number of rows of the second table T2 corresponds to the number of different values that the “Group” field can take multiplied by the number of values that the “Size” field can take. At the end of the synthesis it may be the case that an identifying n-tuple does not correspond to any individual of the first table T1. In that case the corresponding row is automatically deleted in order to reduce the memory space occupied by the second table T2. Thus, in the case of the type in FIG. 4, there are 29 rows as indicated in the frame 112. Through the synthesis operation, the non-classifying field “Result” has been determined. In this case it is a complex field of the distribution type. The displaying interface provides for representing each cell containing a complex data item of the distribution type in the form of a graduated axis on which is recorded the number of times that a given value of the “Result” field of the first table T1 is encountered in the batch of first statistical units, which batch corresponds to the second statistical unit in question, i.e. to a given value of the n-tuple of identifying fields. If the field is of another type, a suitable graphical presentation is proposed to the user. As described earlier, the interface 110 exhibits all the features of a spreadsheet program adapted for complex data items.

Advantageously, the software has a feature (indicated by the reference 33 in FIG. 2) for producing a cross-tabulated table by choosing two classifying fields from the plurality of classifying fields of a second table as row field and column field respectively; then by choosing a field from the remaining fields of the second table as the chosen field; and to present the complex data items of the chosen field in a cross-tabulated table, the rows of which correspond to the values of the row field and the columns to the values of the column field.

In FIG. 5 onwards, another table of complex data items T2′ is used as an example. In particular, the graphical representation of the complex field “Salary” will be noted, which is of the interval type. As represented in FIG. 5, first the “Cross-tabulated table” function is selected from the “Operation” menu 116. A window 133 like the one represented in FIG. 6 is then displayed. The window 133 presents a table 134 with two columns and three rows. The first column recalls the three parameters to be defined in order to produce the cross-tabulated table: the classifying field of the second table T2′ which will be presented in row form, the classifying field of second table T2′ which will be presented in column form, and the field chosen from the remaining fields which chosen field will be presented in the cells of the cross-tabulated table, are to be defined. It is to be noted that the chosen field can be a classifying field or a non-classifying field. The cells of the second column “Attribute” of the table 134 can be set with parameters by means of the scrolling menu 135 that picks up all the fields of the second table T2′. The user starts the construction of the cross-tabulated table by pressing the “Validate” button of the window 133. If necessary, if the second table of complex data items includes more than two classifying fields, it is then necessary to combine the complex values of a batch of second statistical units which have identifying n-tuples that are identical as regards the coordinates according to the chosen row and column fields. Furthermore, if the chosen field is a classifying field characterized by conventional data items, it is necessary to proceed with a synthesis operation. The steps of this synthesis operation have been described above.

At the end of the operation 33, the displaying interface 110 provides for presenting the cross-tabulated table obtained. More specifically, the interface 110 provides for graphically presenting the contents of the cells of the cross-tabulated table, as represented in FIG. 7. In this figure, there is represented a cross-tabulated table 136 produced from the second table T2′ of FIG. 5 according to the settings indicated in the table 134 of FIG. 6.

According to the same principles, a cross-tabulated table can be obtained, the columns of which successively present several classifying fields of the table T′2. For this purpose, the user is provided with the option of selecting several classifying fields of the table T′2 as fields that must be presented as columns. In this variant, the interface of FIG. 6 is modified to let the user associate simultaneously several fields with a cell of the second column of the table 134.

At the end of the work for preparing complex data items, the history of which is reproduced schematically in the frame 113 of the interface 110, the user continues by directing his complex analysis onto a second table of complex data items.

Although the invention has been described with reference to a particular embodiment, it is very clear that the invention is not at all limited to this embodiment and that it includes all the equivalent techniques of the means described and their combinations if they fall within the scope of the invention.

In particular, although the first table T1 has been described as a table of conventional data items, it is clear that the table T1 can contain complex fields. The import means can therefore allow the importing of files containing complex data items. Likewise, the non-classifying fields of the second data table can be conventional fields obtained by an aggregation operation of a batch of first statistical units. For this purpose, the scrolling menu of the window 120 of FIGS. 3A and 3B can be modified so as to present aggregation operations of the mean, minimum and maximum types or the equivalent.

1. A method for processing data by means of a computer (3) having access to data in the form of a first table of conventional data items (T1) containing a plurality of first fields (j) and a plurality of first statistical units (i), characterized by the steps of:
making available to a user a field selection interface for selecting fields from said first fields as classifying fields, then at least one field from said first fields that have not been selected as classifying fields as non-classifying field;
constructing a second table of complex data items containing a plurality of second fields and a plurality of second statistical units, a complex data item being understood as a data item requiring several conventional data items to define it, said plurality of second fields being made up of a plurality of selected classifying fields and at least one selected non-classifying field, said second table having a number of columns corresponding to the number of said second fields and a number of rows corresponding to the number of said second statistical units, which is at most equal to the product of the numbers of possible values of each of said classifying fields;
determining an identifying n-tuple associated with each of said second statistical units so as to identify each of said second statistical units by an identifying n-tuple, each coordinate of which corresponds to a possible value from one of said classifying fields, and completing the corresponding cells of said second table;
synthesizing, by means of a synthesis rule, a complex value of a second statistical unit according to a non-classifying field from a batch of conventional values of first statistical units according to the first field from which said non-classifying field is derived, the first statistical units of said batch having values according to the first fields from which said classifying fields are derived coinciding with the coordinates of said identifying n-tuple of said second statistical unit; and, completing a corresponding cell of said second table with said complex value resulting from the synthesis step with the aim of producing said second table of complex data items (T2, T′2).

2. The method as claimed in claim 1, characterized in that it includes an additional step which involves graphically representing said complex values of the second table of complex data items on a displaying interface in order to allow said second table to be viewed by a user.

3. The method as claimed in claim 1, characterized in that it includes the steps of:
making available to a user a choosing interface for choosing two classifying fields from said plurality of classifying fields as row field and column field, and one field from said second fields that have not been chosen from said second table as the field chosen to be represented; and,
generating a cross-tabulated table, the rows of which correspond to possible values of said row field, the columns of which correspond to possible values of said column field, and the cells of which contain the complex values of said field chosen to be represented.

4. The method as claimed in claim 3, characterized in that, when said second table includes another classifying field in addition to the fields chosen as row and column fields, either said other classifying field is the field chosen to be represented and said step for generating a cross-tabulated table includes a step for synthesizing a batch of values of second statistical units, or said other classifying field is not the field chosen to be represented and the step for generating a cross-tabulated table includes an aggregation of said batch of values of second statistical units, said second statistical units of said batch having identifying n-tuple coordinates according to the two coordinates corresponding to the row and column fields which are identical.

5. The method as claimed claim 1, characterized in that the method includes an initial import step for importing data of various formats in order to construct said first table of conventional data items according to a predetermined format.

6. The method as claimed in claim 5, characterized in that said first table resulting from the import step is a first raw table, and in that the method includes a filtering step which involves filtering the content of said first raw table in order to obtain said first table of conventional data items (T1).

7. The method as claimed claim 1, characterized in that it includes a step which involves making available to a user a range-editing interface for defining the range of possible values of a first field so as to order said values in order to be able to graphically present the complex values of the non-classifying field derived from said first field.

8. The method as claimed claim 1, characterized in that it includes a step of making available to a user a synthesis rule selection interface for selecting the synthesis rule associated with said non-classifying field during said synthesis step.

9. A computer-based architecture programmed by means of a data processing computer program and able to execute its instructions, said data processing computer program including instructions that can be executed to implement all the steps of the method according to claim 1, characterized in that it includes:
a computer (3) having access to data in the form of a first table of conventional data items (T1) containing a plurality of first fields (j) and a plurality of first statistical units (i),
a field selection means able to select fields as classifying fields from said plurality of first fields, and to select at least one field as non-classifying field from said first fields that have not been selected as classifying fields;
a means for producing a second table of complex data items containing a plurality of second fields formed of a plurality of said classifying fields and at least one said non-classifying field, and a plurality of second statistical units respectively identified by an identifying n-tuple, each coordinate of which corresponds to a possible value of one of said classifying fields,
a means for determining second statistical units which is able to determine said identifying n-tuples from possible values of said first fields selected as classifying fields; and,
a synthesis means able to compute a complex value of a second statistical unit according to said non-classifying field, from a batch of conventional values of first statistical units according to the first field from which said non-classifying field is derived, the first statistical units of said batch having values according to the first fields from which said classifying fields are derived coinciding with the coordinates of said identifying n-tuple of said second statistical unit.

10. The programmed computer-based architecture as claimed in claim 9, characterized in that it includes a displaying module able to graphically present said complex values.

11. The programmed computer-based architecture as claimed in claim 9, characterized in that it includes a choosing means able to choose two classifying fields from said plurality of classifying fields as row field and column field, and to choose one field from said second fields that have not been chosen from said second table as the field chosen to be represented, and cross-tabulated table generation means able to generate a cross-tabulated table, the rows of which correspond to possible values of said row field, the columns of which correspond to possible values of said column field, and the cells of which contain the complex values of said field chosen to be represented.

12. The programmed computer-based architecture as claimed in claim 9, characterized in that it includes a data import means able to construct said first table of conventional data items according to a predetermined format.

13. The programmed computer-based architecture as claimed in claim 12, characterized in that it includes a filtering means for filtering the content of said first table constructed by said import means, called first raw table, in order to obtain said first table of conventional data items.

14. The programmed computer-based architecture as claimed in claim 9, characterized in that it includes a range-editing means for defining the value range of possible values of a first field with the aim of ordering said values in order to be able to graphically present the complex values of the non-classifying field derived from said first field.

15. The programmed computer-based architecture as claimed in claim 9, characterized in that it includes a synthesis rule selection means for selecting the synthesis rule associated with said non-classifying field during said synthesis step.

16. The method as claimed in claim 2, characterized in that it includes the steps of:
making available to a user a choosing interface for choosing two classifying fields from said plurality of classifying fields as row field and column field, and one field from said second fields that have not been chosen from said second table as the field chosen to be represented; and,
generating a cross-tabulated table, the rows of which correspond to possible values of said row field, the columns of which correspond to possible values of said column field, and the cells of which contain the complex values of said field chosen to be represented.

17. The method as claimed claim 2, characterized in that the method includes an initial import step for importing data of various formats in order to construct said first table of conventional data items according to a predetermined format.

18. The method as claimed claim 2, characterized in that it includes a step which involves making available to a user a range-editing interface for defining the range of possible values of a first field so as to order said values in order to be able to graphically present the complex values of the non-classifying field derived from said first field.

19. The method as claimed claim 2, characterized in that it includes a step of making available to a user a synthesis rule selection interface for selecting the synthesis rule associated with said non-classifying field during said synthesis step.

20. The programmed computer-based architecture as claimed in claim 10, characterized in that it includes a choosing means able to choose two classifying fields from said plurality of classifying fields as row field and column field, and to choose one field from said second fields that have not been chosen from said second table as the field chosen to be represented, and cross-tabulated table generation means able to generate a cross-tabulated table, the rows of which correspond to possible values of said row field, the columns of which correspond to possible values of said column field, and the cells of which contain the complex values of said field chosen to be represented.
